(19) United States
(12) Patent Application Publication
(10) Pub. No.: US 2003/0081763 A1
(43) Pub. Date: May 1, 2003

(54) Efficient echo channel, estimation mechanism for an ADSL echo canceller

(76) Inventors: Song-Nien Tang, Kaohsiung (TW); Ching-Kae Tzuo, Hsinchu Hsien (TW)

Correspondence Address: BIRCH STEWART KOLASCH & BIRCH, PO BOX 747, FALLS CHURCH, VA, 22040-0747, US

(21) Appl. No.: 10/107,054

(22) Filed: Mar. 28, 2002

(30) Foreign Application Priority Data
Oct. 30, 2001 (TW) 90126924

(51) Int. Cl. H04M 9/08

(52) U.S. Cl. 379/406.01

(57) ABSTRACT

An efficient dual time and frequency domain echo channel estimation scheme that does not need any multiplier in the implementation of its frequency domain component. The scheme applies to echo canceling in typical ADSL applications. It can be easily adapted and extended to other applications such as, but not limited to, HDSL and VDSL in which echo channel estimation and echo canceling are necessary.

### BACKGROUND OF THE INVENTION

1. Field of the Invention

The present invention propose an efficient time-domain and frequency-domain, dual domain, echo channel estimation mechanism that does not need 2 multiplier in the implementation of its frequency-domain component. The mechanism is applied to echo canceling in typical ADSL application. It can be easily adapted and extended to other applications such as, but not limited to, HDSL and VDSL that echo channel estimation and in which echo canceling is necessary.

2. Description of the Related Art

ADSL systems achieve higher rates of data communication over a twisted-pair telephone loop. Because of imperfect impedance matching between an ADSL transceiver output and twisted-pair loop over a wide frequency band, an echo may be created when the transmitted signal is passing through the loop and partially reflected back from a hybrid circuit and/or remote transceiver end in the ADSL link. In other words, the echo is an undesired leakage of transmitted signals from transmitter and feedback into a near-end co-located receiver. It causes great interference to intended signal reception.

Two operating modes have been specified in ADSL standards for dealing with the feedback echoes, namely, the frequency-division-multiplexed (FDM) mode and Echo-Cancel (EC) mode. In the FDM mode, bandwidth of the loop is separated into disjointed parts for downstream and upstream directions respectively and, thus, the echo is reduced to its minimum due to less signal coupling transmit to receive paths. In the EC mode, the ADSL modem uses an overlapped data rate over the link and improve the transmission throughput. The echo is inevitably higher due to this overlapped bandwidth and, thus, an efficient echo canceller is needed to eliminate the echo interference for frequency-overlapped option of data transmission.

A conventional echo canceller uses a finite response filter (FIR) with a long tap to model the echo channel and cancel the echo in time domain. Another efficient architecture is based on dual domain, time-domain and frequency-domain, as shown in FIG. 1, to reduce computational complexity for practical hardware implementation. Frequency-domain echo channel estimation 115 estimates the echo channel response based on an initial period of training. In general, no far-end signals are transmitted to RX-end according to the ADSL standard in this training period. The echo path typically includes transmit filter 104, digital to analog converter (DAC) 105, hybrid circuit 106, analog to digital converter (ADC) 107, receive filter 108, time domain equalizer 109. During the training period, a periodic signal is transmitted and the switch 112 switches to position 1. An adaptive algorithm utilizes frequency domain transmit signal X(f) and receive signal D(f) to generate frequency domain echo channel estimate W(f). At the end of training period, the echo channel response estimate W(f) is transformed into time domain using IFFT to form a synthesized time domain echo channel estimate w(t). Time domain echo replica synthesis 117 performs linear convolution of a transmitted signal x(t) with the time-domain echo channel estimate w(t) to synthesize an echo replica. Meanwhile, the far-end signal is received at RX-end, and the switch 112 switches to position 2. The synthesized echo from convolution is subtracted from the received signal, S(t), to generate echo-removed data, d(t), which is close to the expected far-end signal.

The function block diagram of the frequency-domain echo channel estimation 115 is shown in FIG. 2. It is based on a general and well-known LMS (least-mean-square) adaptive algorithm. The periodic TX symbol X(f) is replicated k times to form the replicated signal Xₖ(f), and D(f) is the desired output of echo channel in frequency domain. A conventional LMS algorithm referred to FIG. 2 is describe as below:

Y(f)=Xₖ(f)·W₀(f) (eq1)

E(f)=D(f)−Y(f) (eq2)

W(f)=W₀(f)+μ₁·E(f)·Xₖ*(f) (eq3)

W(f) is the newly updated estimated echo channel frequency response, and W₀(f) is the same estimated echo channel frequency response obtained in previous iteration. The multiplier 202 multiplies Xₖ(f) by W₀(f) to generate frequency domain echo replica Y(f). The subtractor 203 subtracts frequency domain echo replica Y(f) from the actual frequency domain echo signal D(f) to obtain the error signal E(f). The update of the frequency domain echo channel is formed by multiplying step-size coefficient μ₁, error signal E(f), and the conjugate replicated signal Xₖ(f), through multiplier 204, and multiplier 205. The newly updated estimated echo channel response W(f) is obtained by adding the previous estimated echo channel response W₀(f) with the update of the frequency domain echo channel. Each iteration is performed frame by frame and a set of coefficients (stored in RAM 207) for echo channel estimation is achieved after a certain number of iterations.

As is also obvious in FIG. 2, three multipliers are needed and all the related calculation is done with complex numbers in frequency domain, consuming both hardware area and power. In addition, an extra memory is needed for the storage of X(f) to compensate for the latency between X(f) and D(f).

### SUMMARY OF THE INVENTION

The object of the invention is to provide a hardware reduced echo channel estimation mechanism for echo canceller of ADSL application.

To achieve the objective described above, the present invention provides a frequency domain echo channel estimation component comprising adder/subtractor and shift register instead of multiplier. The algorithm on which the frequency domain echo channel estimation component is based is adapted from the LMS adaptive algorithm such that it only needs adder/subtractor and shift register.

Anothor object of the invention is to provide a hardware reduced far end signal removing component for echo canceller of ADSL application. The same method can be applied to the component.

### BRIEF DESCRIPTION OF THE DRAWINGS

The present invention can be more fully understood by reading the subsequent detailed description in conjunction with the examples and references made to the accompanying drawings, wherein:

FIG. 1 shows a conventional time-domain and frequency-domain echo cancel architecture;

FIG. 2 shows the block diagram of frequency-domain echo channel estimation based on the conventional LMS algorithm;

FIG. 3 shows frame structure and its related operations based on the ADSL standard;

FIG. 4 shows the block diagram of frequency-domain echo channel estimation based on the algorithm of the present invention;

FIG. 5 shows the block diagram of far-end signal removing based on the algorithm of the present invention;

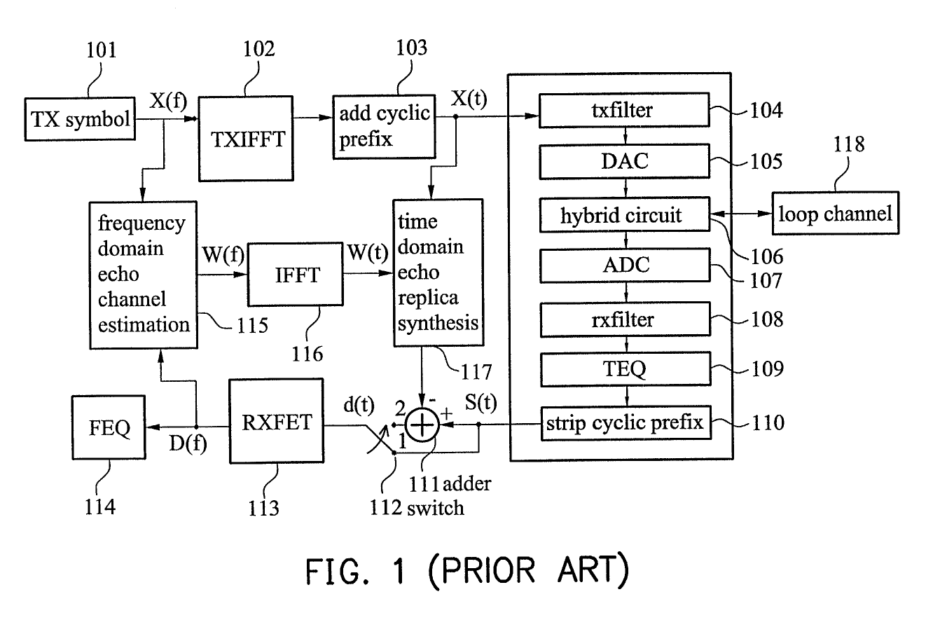

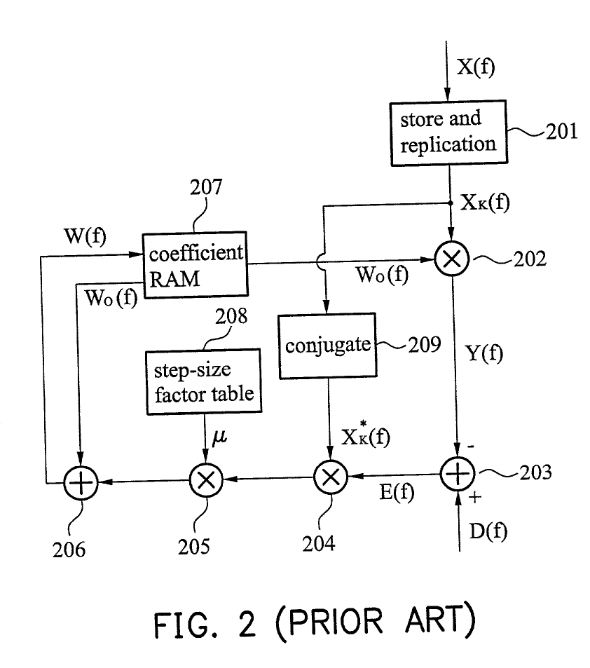

### DETAILED DESCRIPTION OF THE PREFERRED EMBODIMENT

In the embodiment, some modification to the previous algorithm is proposed to reduce hardware area and the number of numerical operations, and is described as follows:

(1) The transmitted TX symbol, X(f), has the constellation values of 2 to the power of a selected value, “a”, during the training period. That is, X(f) is specifically defined and can be represented as below:

X(f)=sgn(X_{g}(f))·2^{a}

1 for x>0

Where sgn(x)=0 for x=0

−1 for x<0 X_{g}(f) represents a predefined sequence. The value of “a” is a positive integer and depends on average TX signal power level. The choice of “a” depends on two criterias. That is, the power of X(f) in the training period should be similar to that in other state, and should satisfy the limitation of AGC(auto gain control).

(2) The step-size factor μ₁ is also set to be the value of 2 to the power of “b” where b is also a positive integer.

(3) At the end of the training period, the echo-removed data d(t) is generated. The signal d(t) contains the far-end signal from ATU-C end that will interfere with echo channel estimation at showtime(i.e., the time when data transmission and reception begin). With a suitable mechanism of removing the far-end signal from d(t), another error term signal E′(f) will be produced. A fine-tuning process of frequency-domain estimate W(f) is introduced with this E′(f), (i.e., the E(f) in eq3 is replaced by E′(f)) to deal with the possible variation of echo channel for a long period. In addition, the known and proposed variation of LMS algorithm is also introduced in this operation. That is, the factor Xₖ*(f) in eq3 is replaced by sgn(Xₖ*(f)).

With new terms introduced as described above, the original algorithm of echo channel estimation(eq1-eq3) can be modified as follows:

Y(f)=sgn(Xₖ*(f))·2^{a}W₀(f) (eq4)

E(f)=D(f)−Y(f) (eq5)

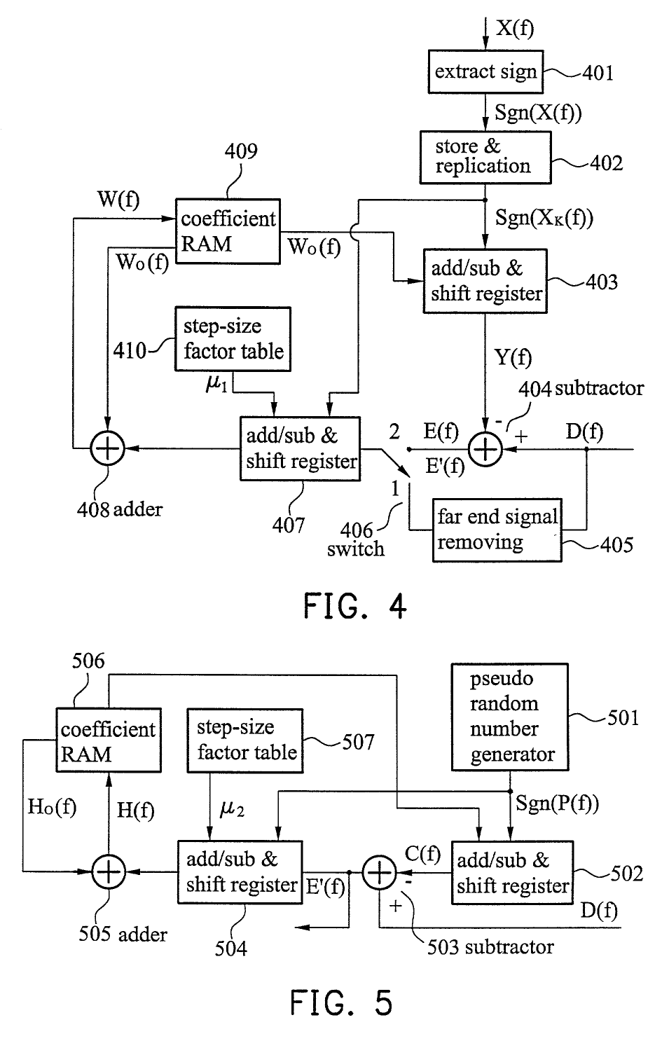

As shown in FIG. 4, the multiplier 202 is replaced by add/sub and shift register 403 for receiving estimated echo channel frequency response W(f). The value of “a” is used to control shift register of the add/sub and shift register 403 and the sign, sgn(Xₖ*(f)), is used to control the add/sub of the add/sub and shift register 403 to get the frequency domain echo replica Y(f).

During the training period, the estimated echo channel frequency response are updated as follows:

W(f)=W₀(f)+2^{b}·E(f)·sgn(Xₖ(f))*·2^{a}=W₀(f)+2^{a+b}·E(f)·sgn(Xₖ(f))* (eq6)

As shown in FIG. 4, the multiplier 204 and the multiplier 205 are replaced by add/sub and shift register 407 for receiving the error signal when the switch is at position 2. The value “a” of the received frequency domain signal X(f)and the value “b” of the step sized factor are used to control shift register of the add/sub and shift register 407 to get the update of the estimated echo channel frequency response, which having sign “sgn(Xₖ(f))*”.

During the fine-tuning part of show time, the estimated echo channel frequency responses are updated instead as follows:

W(f)=W₀(f)+2^{b}·E′(f)·sgn(Xₖ(f))* (eq7)

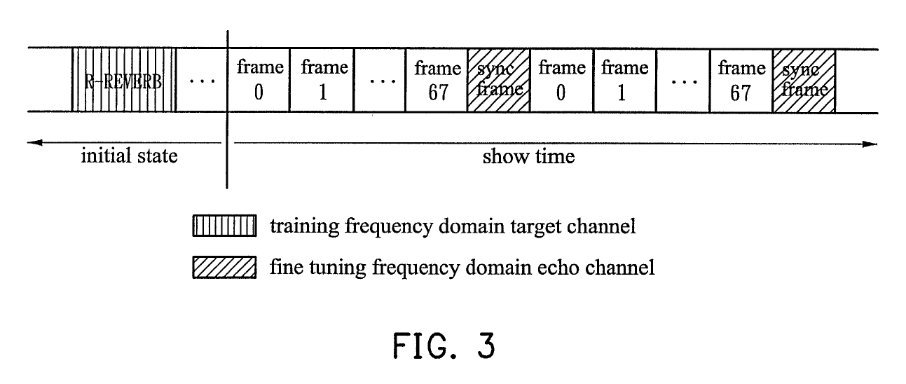

The switch 406 provides the training period for E(f) and the fine-tuning period for the far end error signal E′(f). The error term E′(f) for updating in eq.7 removes the far-end signals through the far-end signal removing block 405 as well as estimating echo channel. In the ADSL system, the non-ideal loop channel is first equalized and shortened by TEQ to a target channel impulse response. A simple mechanism is introduced here to estimate a frequency domain target channel for synthesizing the far-end signal, which should be removed before the updated of echo channel estimate. The related operation is based on the frame structure defined in ADSL as shown in FIG. 3. The pseudo random downstream codes (PRD codes) are transmitted in the R-REVERB state during the initial period and each synch frame at show time. The target channel estimation is completed at R-REVERB state, and each synch frame for generating the E′(f), and the fine-tuning of echo channel in eq.7 is done during each synch frame period. By the ADSL standard, the PRD codes should be mapped to 4_QAM-constellation symbol, thus the constellation value during these periods can be represented as 2⁰·sgn(P(f)) where P(f) is the PRD constellation values.

FIG. 5 shows the block diagram of far-end signal removing based on the algorithm of the present invention. The LMS algorithm for far-end signal removing is similar to the process of echo channel estimation (eq.4-eq.7) is operated as below: The step size factor μ₂ is also set to be the value of 2 to the power of “c” where c is also a positive integer)

C(f)=P(f)·H(f)=sgn(P(f)·2⁰·H₀(f) (eq.8)

E′(f)=D(f)−C(f) (eq.9)

H(f)=H₀(f)+μ₂·E′(f)·P*(f)=H₀(f)+2^{c}E′(f)·sgn(P(f)* (eq.10)

The multiplication operation of “sgn(P(f))·2⁰H₀(f)” in eq.8 is implemented by add/sub and shift register 502 for receiving estimated target channel frequency response H(f). The sign “sgn(P(f))” of the pseudo random codes generator 501 is used to control the add/sub of the add/sub and shift register 502.

The multiplication operation of “2^{c}E′(f)·P*(f)” in eq. 10 is implemented by add/sub and shift register 504 for receiving the far end error signal E′(f). The value “c” of the step size factor store block 507 is used to control the shift register of the add/sub and shift register 504. The sign “sgn(P(f))” of the pseudo random codes generator 501 is used to control the add/sub of the add/sub and shift register 504.

In hardware, the operations of eq.4-eq.10 are implemented with fix-point complex numbers. Accordingly, the multiplication operation of sgn(Xₖ(f))·W₀(f) in eq.4 can be replaced by addition and subtraction of real part and imaginary part of W₀(f) with a suitable control governed by sgn(Xₖ(f)). The multiplication with 2^{a} can be implemented with a simple “shift” of bits in fix-point numerical operation. Thus, the multiplication in eq.4 can be implemented simply by addition/subtraction operations combined with “shift” and suitable controls. The same principle can also be introduced to the multiplication in eq.6, eq7, eq8 and eq.10.

As shown in FIG. 4 and FIG. 5, no multipliers are needed in this architecture. The multipliers are replaced by the add/sub and shift register. Thus, a great deal of hardware area can be saved and memory size for the storage of transmission signal symbol can be reduced. In addition, due to the fact that multiplier is replaced by add/sub, the timing margin is increased in hardware implementation—this implies that this hardware circuit can be operated at a higher speed in cases when needed.

While the invention has been described with reference to various illustrative embodiments, the description is not intended to be construed in a limiting sense. Various modifications of the illustrative embodiments, as well as other embodiments of the invention, will be apparent to those persons skilled in the art upon reference to this description. It is therefore contemplated that the appended claims will cover any such modification or embodiments as may fall within the scope of the invention defined by the following claims and their equivalents.

What is claimed is:

1. A frequency domain echo channel estimator, comprising:
an extractor for extracting a sign of a received frequency domain signal;
a replication block for receiving the sign and generating a power of the received frequency domain signal;
a first operate block having an add-subtractor controlled by the sign and a shift register receiving a estimated echo channel frequency response and controlled by the power of the received frequency domain signal and generating a frequency domain echo replica;
a subtractor for subtracting the frequency domain echo replica from an actual frequency domain echo signal to generate an error signal;
a store block for storing a power of a step size factor;
a second operate block having an add-subtractor controlled by the sign and a shift register receiving the error signal and controlled by the power of the received frequency domain signal and the step size factor and generating an update of the estimated echo channel frequency response;
an adder for adding the update of the estimated echo channel frequency response to the estimated echo channel frequency response to generate a next estimated echo channel frequency response received by the first operate block; and
a RAM module for storing the estimated echo channel frequency response and the next estimated echo channel frequency response.

2. A method for estimating frequency domain echo channel, comprising the steps of:
a. starting an echo channel training state and setting an estimated echo channel frequency response to initial value;
b. extracting a sign from a received frequency domain signal;
c. replicating the received frequency domain signal and generating a power of the received frequency domain signal;
d. receiving an estimated echo channel frequency response by a shift register of a first operating block controlled by the power of the received frequency domain signal and controlling an adder-subtractor of the first operate block by the sign to generating a frequency domain echo replica;
e. substracting the frequency domain echo replica from an actual frequency domain echo signal to generate an error signal;
f. receiving the error signal by a shift register of a second operating block controlled by the power of the received frequency domain signal and a step size factor and controlling an adder-subtractor of the second operate block by the sign to generating an update of the estimated echo channel frequency response;
g. adding the update of the estimated echo channel frequency response to the estimated echo channel frequency response to generate a next estimated echo channel frequency response received by the first operate block;
h. returning to step b if the echo channel training state does not end; otherwise, stopping the estimated echo channel frequency response update.

3. A frequency domain echo channel estimator, comprising:
an extractor for extracting a sign of a received frequency domain signal;
a replication block for receiving the sign and generating a power of the received frequency domain signal;
a first operate block having an add-subtractor controlled by the sign and a shift register receiving a estimated echo channel frequency response and controlled by the power of the received frequency domain signal and generating a frequency domain echo replica;
a first subtractor for subtracting the frequency domain echo replica from an actual frequency domain echo signal to generate an error signal;
a removal block for removing a far end signal and generating a far end error signal;
a switch for selecting the error signal or the far end error signal;
a first storage block for storing a power of a step size factor;
a second operate block having an add-subtractor controlled by the sign and a shift register receiving the error signal and controlled by the power of the received frequency domain signal and the step size factor and generating an update of the estimated echo channel frequency response;
a first adder for adding the update of the estimated echo channel frequency response to the estimated echo channel frequency response to generate a next estimated echo channel frequency response received by the first operate block; and
a first RAM module for storing the estimated echo channel frequency response and the next estimated echo channel frequency response.

4. The frequency domain echo channel estimator as claimed in claim 3, wherein the remove block comprises:
a pseudo random number generator for generating frequency domain pseudo random codes which is represented by a sign of the frequency domain pseudo random codes;
a power of the received frequency domain signal;
a third operate block having an add-subtractor controlled by the sign and a shift register receiving an estimated target channel frequency response and generating a frequency domain target channel synthesized signal;
a second subtractor for subtracting the frequency domain target channel synthesized signal from an actual frequency domain target channel signal to generate the far end error signal;
a second storage block for storing a power of a second step size factor;
a fourth operate block having an add-subtractor controlled by the sign of the frequency domain pseudo random codes and a shift register receiving the far end error signal and controlled by the power of the second step size factor and generating an update of the estimated target channel frequency response
a second adder for adding the update of the estimated target channel frequency response to the estimated target channel frequency response to generate a next estimated target channel frequency response received by the third operate block; and
a second RAM module for storing the estimated target channel frequency response and the next estimated target channel frequency response.

5. A method for removing far end signal, comprising the steps of:
a. starting target channel training state and setting an estimated target channel frequency response to initial value;
b. generating frequency domain pseudo random codes;
c. extracting a sign from the frequency domain pseudo random codes;
d. receiving an estimated target channel frequency response by a shift register of a first operate block and controlling an adder-subtractor of the first operate block by the sign of the pseudo random codes to generate a frequency domain target channel synthesized signal;
e. subtracting the frequency domain target channel synthesized signal from an actual frequency domain echo signal to generate an far end error signal;
f. receiving the far end error signal by a shift register of a second operate block controlled by the power of a step size factor and controlling an adder-subtractor of the second operate block by the sign of the pseudo random codes to generating an update of the estimated target channel frequency response;
g. adding the update of the estimated target channel frequency response to the estimated target channel frequency response to generate a next estimated target channel frequency response received by the first operate block;
h. returning to step b if the target channel training state does not end; otherwise, stopping updating the estimated target channel frequency response.
